(19) United States
(12) Patent Application Publication
(10) Pub. No.: US 2023/0072878 A1
(43) Pub. Date: Mar. 9, 2023

(54) AUTOMATED TOPOLOGY-AWARE DEEP LEARNING INFERENCE TUNING

(71) Applicant: Dell Products L.P., Round Rock, TX (US)

(72) Inventors: Yunfan Han, Austin, TX (US); Rakshith Vasudev, Austin, TX (US); Dharmesh M. Patel, Round Rock, TX (US)

(21) Appl. No.: 17/468,860

(22) Filed: Sep. 8, 2021

(51) Int. Cl. G06N 20/00; G06N 5/04; G06F 9/50

(52) U.S. Cl. CPC G06N 20/00; G06N 5/04; G06F 9/5083; G06F 9/505

(57) ABSTRACT

Methods, apparatus, and processor-readable storage media for automated topology-aware deep learning inference tuning are provided herein. An example computer-implemented method includes obtaining input information from one or more systems associated with a datacenter; detecting topological information associated with at least a portion of the systems by processing at least a portion of the input information, wherein the topological information is related to hardware topology; automatically selecting one or more of multiple hyperparameters of at least one deep learning model based on the detected topological information; determining a status of at least a portion of the detected topological information by processing, during an inference phase of the at least one deep learning model, the detected topological information and data from at least one systems-related database; and performing, in connection with at least a portion of the selected hyperparameters, one or more automated actions based on the determining.

### FIELD

The field relates generally to information processing systems, and more particularly to techniques for processing data using such systems.

### BACKGROUND

Deep learning techniques typically include a training phase and an inference phase. The training phase commonly involves a process of creating a machine learning model and/or training a created machine learning model, which are often compute-intensive procedures. The inference phase commonly involves a process of using the trained machine learning model to generate a prediction. Also, the inference phase can occur in both edge devices (e.g., laptops, mobile devices, etc.) and datacenters.

Inference servers in datacenters often have common attributes and/or functionalities, such as, for example, obtaining queries from one or more sources and sending back predicted results within one or more certain latency constraints without degrading the quality of the prediction(s). Also, as more models are trained, implementing and/or deploying such models at scale presents challenges related to hyperparameters. Conventional deep learning-related approaches include utilization of the same set of hyperparameters across multiple models regardless of the differing topologies associated with the models, which can often limit and/or reduce model performance. Additionally, conventional deep learning-related approaches typically perform hyperparameter tuning exclusively during the training phase, and not during the inference phase.

### SUMMARY

Illustrative embodiments of the disclosure provide techniques for automated topology-aware deep learning inference tuning. An exemplary computer-implemented method includes obtaining input information from one or more systems associated with a datacenter, and detecting topological information associated with at least a portion of the one or more systems by processing at least a portion of the input information, wherein the topological information is related to hardware topology. The method also includes automatically selecting one or more of multiple hyperparameters of at least one deep learning model based at least in part on the detected topological information, and determining a status of at least a portion of the detected topological information by processing, during an inference phase of the at least one deep learning model, the detected topological information and data from at least one systems-related database. Further, the method additionally includes performing, in connection with at least a portion of the one or more selected hyperparameters of the at least one deep learning model, one or more automated actions based at least in part on the determining.

Illustrative embodiments can provide significant advantages relative to conventional deep learning-related approaches. For example, problems associated with performing topology-indifferent hyperparameter tuning exclusively during the training phase are overcome in one or more embodiments through automatically performing topology-aware tuning of deep learning models during an inference phase.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for automated topology-aware deep learning inference tuning in an illustrative embodiment.

FIG. 2 shows an example of an inference workload running on servers in a datacenter in an illustrative embodiment.

FIG. 3 shows an example flow diagram among components within an optimization engine in an illustrative embodiment.

FIG. 4 shows an example code snippet for a JavaScript Object Notation (JSON) file generated by a configurator for a deep learning model in an illustrative embodiment.

FIG. 5 is a flow diagram of a process for automated topology-aware deep learning inference tuning in an illustrative embodiment.

FIGS. 6 and 7 show examples of processing platforms that may be utilized to implement at least a portion of an information processing system in illustrative embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

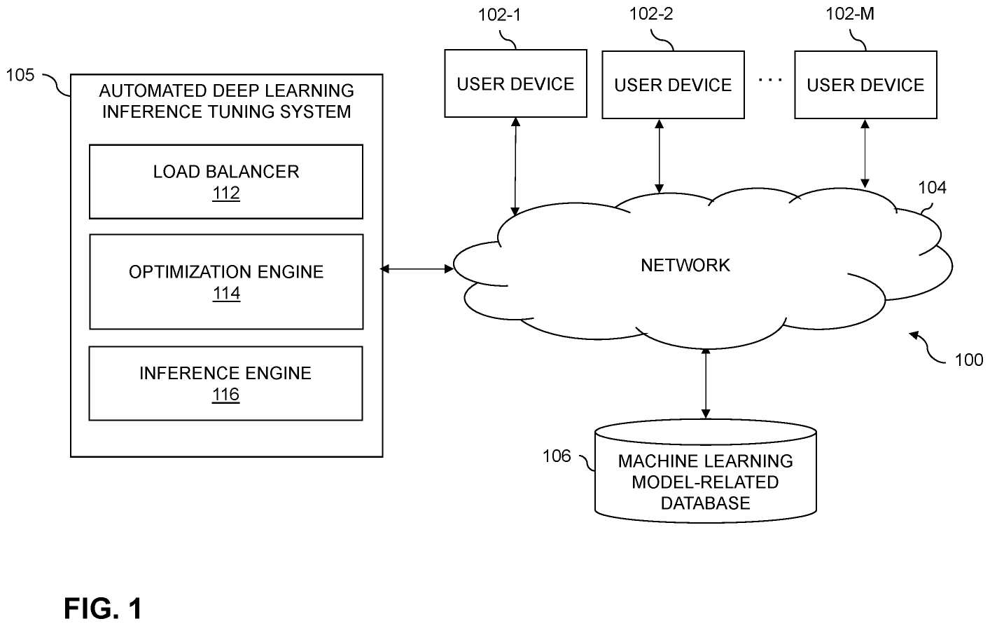

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks” but the latter is assumed to be a component of the former in the context of the FIG. 1 embodiment. Also coupled to network 104 is automated deep learning inference tuning system 105.

The user devices 102 may comprise, for example, mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, automated deep learning inference tuning system 105 can have an associated machine learning model-related database 106 configured to store data pertaining to hyperparameters, hyperparameter values, model attributes, system configuration data, etc.

The database 106 in the present embodiment is implemented using one or more storage systems associated with automated deep learning inference tuning system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with automated deep learning inference tuning system 105 are one or more input-output devices, which illustratively comprise keyboards, displays or other types of input-output devices in any combination. Such input-output devices can be used, for example, to support one or more user interfaces to automated deep learning inference tuning system 105, as well as to support communication between automated deep learning inference tuning system 105 and other related systems and devices not explicitly shown.

Additionally, automated deep learning inference tuning system 105 in the FIG. 1 embodiment is assumed to be implemented using at least one processing device. Each such processing device generally comprises at least one processor and an associated memory, and implements one or more functional modules for controlling certain features of automated deep learning inference tuning system 105.

More particularly, automated deep learning inference tuning system 105 in this embodiment can comprise a processor coupled to a memory and a network interface.

The processor illustratively comprises a graphics processing unit (GPU) such as, for example, a general-purpose graphics processing unit (GPGPU) or other accelerator, a microprocessor, a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows automated deep learning inference tuning system 105 to communicate over the network 104 with the user devices 102, and illustratively comprises one or more conventional transceivers.

The automated deep learning inference tuning system 105 further comprises a load balancer 112, an optimization engine 114, and an inference engine 116.

It is to be appreciated that this particular arrangement of elements 112, 114 and 116 illustrated in automated deep learning inference tuning system 105 of the FIG. 1 embodiment is presented by way of example only, and alternative arrangements can be used in other embodiments. For example, the functionality associated with elements 112, 114 and 116 in other embodiments can be combined into a single module, or separated across a larger number of modules. As another example, multiple distinct processors can be used to implement different ones of elements 112, 114 and 116 or portions thereof.

At least portions of elements 112, 114 and 116 may be implemented at least in part in the form of software that is stored in memory and executed by a processor.

It is to be understood that the particular set of elements shown in FIG. 1 for automated topology-aware deep learning inference tuning involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, automated deep learning inference tuning system 105 and machine learning model-related database 106 can be on and/or part of the same processing platform (e.g., the same Kubernetes cluster).

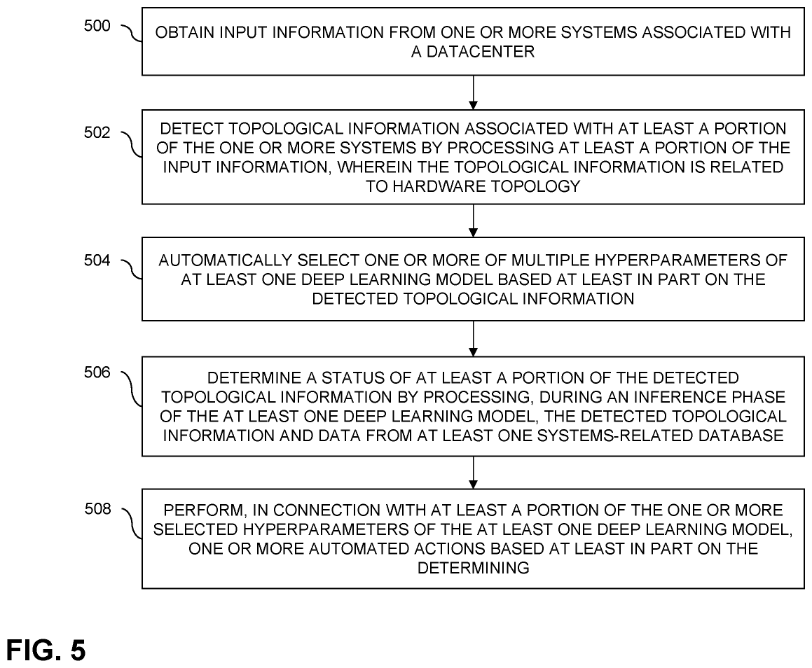

An exemplary process utilizing elements 112, 114 and 116 of an example automated deep learning inference tuning system 105 in computer network 100 will be described in more detail with reference to the flow diagram of FIG. 5.

Accordingly, at least one embodiment includes automated topology-aware deep learning inference tuning methods for one or more servers in a datacenter (which can include one or more collections of systems such as, for example, geographically-distributed computing systems, enterprise computing systems, etc.). Such an embodiment includes utilizing a real-time inference loop to check with at least one database to determine if a given set of topological information (e.g., hardware-related topological information) associated with a machine learning model is new, and if the topological information is not new, retrieving one or more known values from the database(s) without needing to rerun an optimization technique. Such topological information can include, for example, the number of central processing units (CPUs) and/or GPUs in a given system (e.g., a given accelerator), how the CPUs and/or GPUs are connected (e.g., one CPU directly connected to one GPU, one CPU connected to two GPUs via a peripheral component interconnect express (PCIe) switch, etc.), overall system connection information with respect to at least one given accelerator, etc.

Additionally, one or more embodiments can include linking and/or associating with at least one user's machine learning operations pipeline such that, for example, a hardware-specific optimization layer is triggered only if the pipeline is triggered. As used herein, a pipeline is a concept used in a Kubernetes context (e.g., in connection with deep learning techniques). Specifically, a “pipeline” refers to the sequence of operations that are undergone in a given system or platform (e.g., a MLOps platform). In connection with such a pipeline, users (e.g., customers, machine learning engineers, etc.) can utilize a set of items that are defined and well-established from data preprocessing to model production. Also, such a pipeline can include sequences of elements that are engaged (or “triggered”) as and when there is a reason for the pipeline to be engaged or triggered. Such reasons can include, for example, that a dataset was changed (e.g., a given dataset is not coming from the same distribution as previously and/or as another dataset, etc.), a given model has been retrained and is performing better than a given baseline, a bottleneck step in a given process has been reduced and/or eliminated, the base-working case of an existing setup was altered, etc.

In other words, techniques detailed herein in connection with one or more embodiments will not be a disruption to a given user's working setup and will not be required to be triggered every time there is a need to perform inferencing. In such an embodiment, the techniques will only be carried out when a given pipeline is triggered.

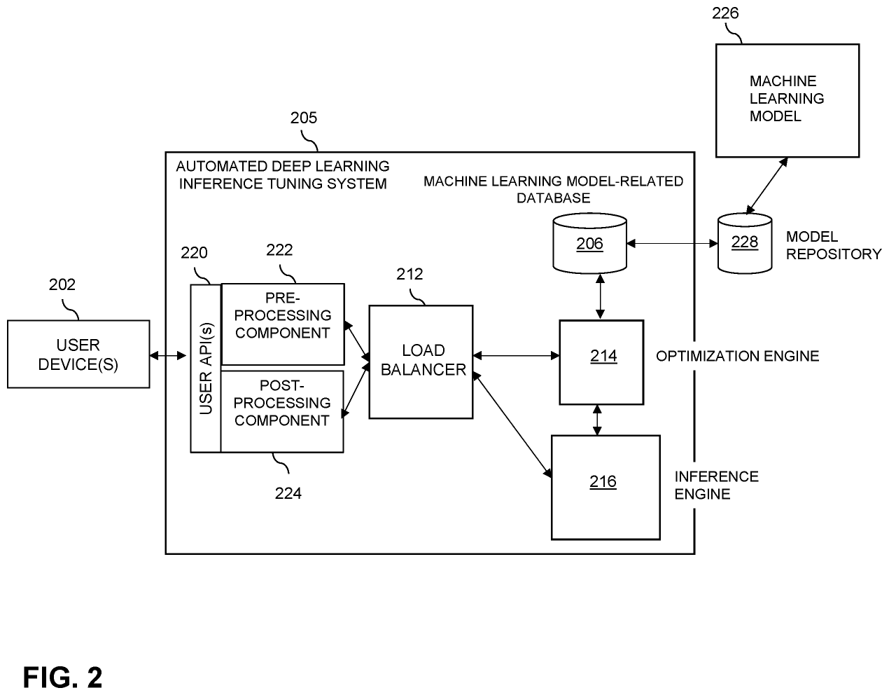

FIG. 2 shows an example of an inference workload running on servers in a datacenter in an illustrative embodiment. By way of illustration, FIG. 2 depicts automated deep learning inference tuning system 205, user device(s) 202, machine learning model 226 and model repository 228 (which, for example, can include storage on a cloud and/or a network file system). As depicted in FIG. 2, automated deep learning inference tuning system 205 includes one or more user application programming interfaces (APIs) 220, pre-processing component 222, post-processing component 224, machine learning model-related database 206 (which, for example, can include storage in Kubernetes), and optimization engine 214 implemented between load balancer 212 and inference engine 216.

As illustrated in FIG. 2, user device(s) 202 initiates the inference request(s) and sends the new data to the pre-processing component 222 via user APIs 220. After pre-processing, the data will be sent to the optimization engine 214 via the load balancer 212, which schedules workloads from different users and evenly distributes the workloads to one or more optimization engines (such as engine 214). The optimization engines 214 will check with database 206, which stores all machine learning models (such as, e.g., machine learning model 226) in connection with a model repository 228. Also, the optimization engine 214 will match the required model received from database 206 and perform one or more optimization operations in connection therewith. Subsequently, finalized hyperparameter sets will be passed along with machine learning model 226 to the inference engine 216, and inference engine 216 will perform the prediction work and send back the results back to the load balancer 212 and then the post-processing component 224, and ultimately the user device(s) 202 will receive the final inference results (via APIs 220).

As further detailed herein, in one or more embodiments, optimization engine 214 performs one or more optimization techniques based at least in part on the hardware topology associated with user device(s) 202 and one or more policy sets. By way of example, in one or more embodiments, a policy set can include aspects such as behaviors of the system, wherein accelerator-specific implementation details are examined across different parts of a stack, and the appropriate algorithm is selected to tune for the best hyperparameters and make intelligent choices for enabling faster inference processing by reducing latencies. An example policy set can be built to be extensible and allowed for later modifications to accommodate new algorithms and/or techniques. As is to be appreciated by one skilled in the art, deep learning models and other artificial intelligence and/or machine learning algorithms commonly include model parameters and model hyperparameters. Model parameters are typically learned from training data (e.g., in a linear regression, the coefficients are model parameters), while model hyperparameters typically vary from algorithm to algorithm and can be tuned in an attempt to optimize the performance and accuracy of the algorithm. By way merely of example, three potential hyperparameters for a gradient boosting regressor algorithm with the corresponding range of values can include the following: criterion: ‘mse,’ ‘mae,’ ‘Friedman_mse;’ max_features: ‘auto,’ ‘sqrt,’ ‘log 2;’ and min_samples_leaf: [1, 2, 3, 4, 5, 6, 7, 8, 9, 10, 11].

Accordingly, in one or more embodiments, once improved hyperparameter sets (e.g., optimal hyperparameter sets) are identified (e.g., within a given period of time), automated deep learning inference tuning system 205 can, for example, automatically implement the identified hyperparameter values and/or provide those values to one or more production systems. Additionally or alternatively, the same type of system can directly use known hypermeter sets (as that of the same type of system) if the hyperparameters are known and/or have been used before on the same configuration(s).

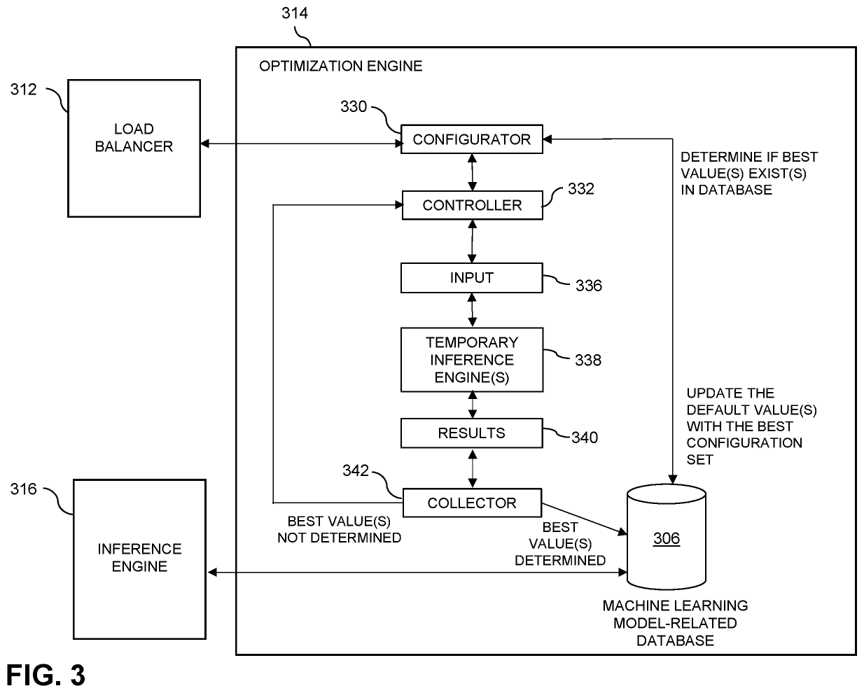

FIG. 3 shows an example flow diagram among components within an optimization engine in an illustrative embodiment. By way of illustration, FIG. 3 depicts load balancer 312, optimization engine 314, and inference engine 316. As also depicted in FIG. 3, optimization engine 314 includes machine learning model-related database 306, configurator 330, controller 332, input 336, temporary inference engine(s) 338, and results 340, as well as collector 342. By way of further description, inference engine 316 represents the final inference engine built with tuned parameters, and temporary inference engine(s) 338 represent one or more temporarily-created engines (in connection with a loop, as further detailed herein) for finding the best hyperparameter set.

As illustrated, FIG. 3 further depicts an example flow diagram of steps carried out by optimization engine 314. For example, based at least in part on input from load balancer 312, configurator 330 detects the topology of the system under test (also referred to simply as system), and based on the hardware topology, automatically determines which hyperparameter(s) (related to at least one given model) is/are the most important hyperparameter(s). Such determinations can be carried out and/or handled using at least one policy set. In one or more embodiments, important hyperparameters can include those that fully satisfy the conditions that are defined for the deployment setting outcome. If the best hyperparameter(s) is/are present in machine learning model-related database 306 already, such hyperparameter(s) is/are sent back to inference engine 316. If the best hyperparameter set is unknown, configurator 330 generates one or more initial values based on a set of one or more rules (e.g., 15 millisecond (ms) latency thresholds can be adjusted by the configurator 330, and runtime parameters such as “start_from_device” can be set to auto, force on or force off, etc.). Additionally, configurator 330 automatically generates the corresponding configurations into JSON format, selects one or more algorithms from controller 332, and sends such information to controller 332.

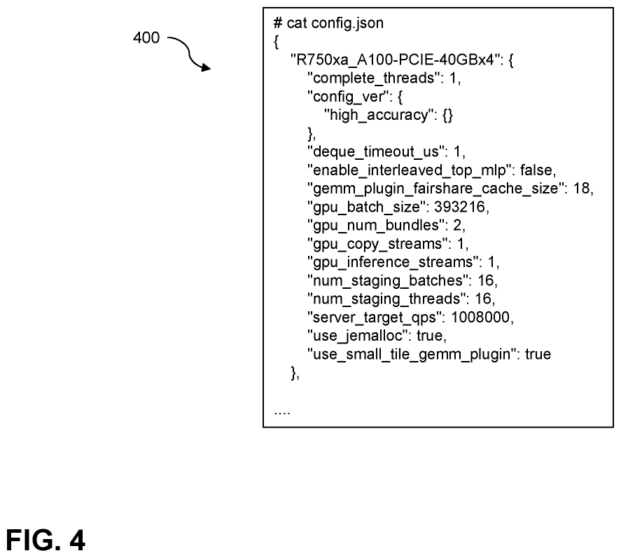

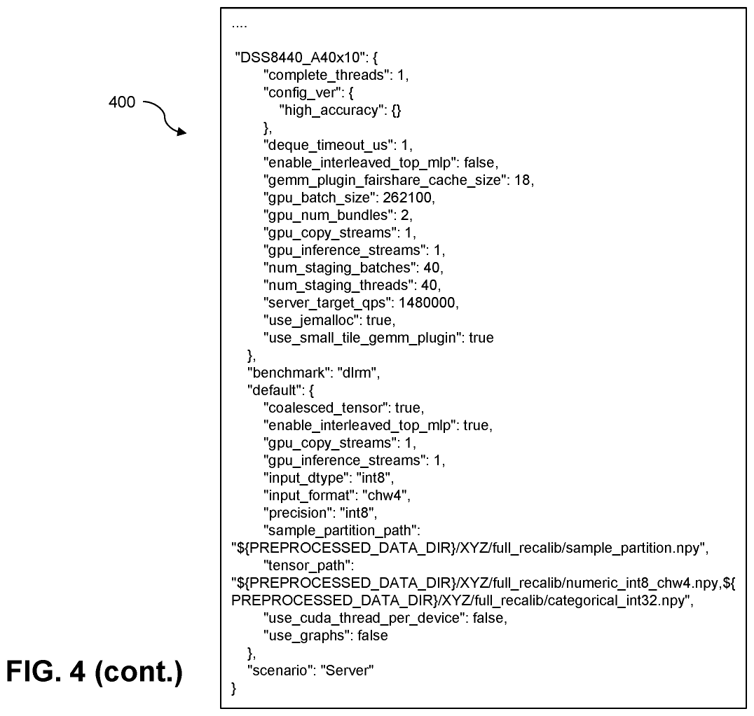

FIG. 4 shows an example code snippet for a JSON file generated by a configurator for a deep learning model in an illustrative embodiment. In this embodiment, example code snippet 400 is executed by or under the control of at least one processing system and/or device. For example, the example code snippet 400 may be viewed as comprising a portion of a software implementation of at least part of automated deep learning inference tuning system 105 of the FIG. 1 embodiment. The example code snippet 400 illustrates an example of the complexity in the different possible sets of arguments to deliver the highest performance. More specifically, in one or more embodiments, there can be many arguments to search for and/or implement to find the best performance-yielding system, as illustrated by the example depicted in FIG. 4.

It is to be appreciated that this particular example code snippet shows just one example implementation of a JSON file generated by a configurator for a deep learning model, and alternative implementations of the process can be used in other embodiments.

Referring again to FIG. 3, controller 332 holds the policy modules, which can be implemented individually. In one or more embodiments, controller 332 can support algorithms such as, for example, binary searches, genetic algorithms, Bayesian methods, MetaRecentering, covariance matrix adaptions (CMA), Nelder-Mead, differential evolution, etc. Also, controller 332 can be extended, and the policy inside controller 332 can be defined and added, for instance, as supplemented from human experience and knowledge.

By way of example, if there are interconnections between parameters, such interconnections can be implemented in connection with the controller 332. For instance, if it is desired to let gpu_copy_steams always be less than or equal to gpu_inference_streams, then the following can be set as one policy: config[“gpu_copy_streams”]config[“gpu_inference_streams”]. By way of further example, an engineer can adjust runs such as by providing better initial values and/or assigning a certain range of each parameter to limit the reach range, so the number of runs can be reduced and/or runs can be finished faster. Additionally or alternatively, walltime can be set in policy as well, which can be useful in a situation such as when only two hours can be given to the optimization, and the software will try its best to find the best parameters in the given time. Such a circumstance can be controlled by setting this as a stop point, wherein the best values found in the given time range can be automatically updated to production servers. Policy also can be set, for example, to determine if the inference engine needs to be rebuilt or not, and/or if some hypermeters need the inference engine to be rebuilt. Policy can adjust such changes based at least in part on relevant rules.

Also, one or more conditions can be extended, and based at least in part on such conditions, policy can help to reduce the time spent on finding the best hypermeter set. In such an embodiment, example conditions (i.e., constraints that are to be met while executing) can include domain expert recommendations (e.g., a recommendation can suggest running batch sizes between 256 and 512 for all multiples of 64), the type of deployments that the inference system(s) is/are subjected to, whether to optimize for quality of service or system throughput, how model sparsity is addressed, if a human in the loop is needed, etc.

Referring again to FIG. 3, optimization engine 314 will try out different values of hyperparameter sets (such as those, for example, shown in FIG. 4) by passing one set of hyperparameters as input 336 to temporary inference engine(s) 338 and collecting the results 340 until the best set of hyperparameters is determined.

As also depicted in FIG. 3, collector 342 checks and translates the results 340, and outputs and/or displays the translated results via at least one user interface (e.g., a web graphical user interface (WebGUI)). More specifically, in at least one embodiment, collector 342 analyzes the results 340 to determine if the best value has been determined, or else continues searching for the best (hardware-specific) hyperparameter values (e.g., by going back to controller 332 and following the policy set to determine what can be executed next). Additionally, in such an embodiment, collector 342 displays progress in at least one WebGUI, showing the performance gain(s) from the default values, as well as the optimized value(s). Collector 342 also saves any known good results in machine learning model-related database 306, and applies (via machine learning model-related database 306) at least a portion of those hyperparameters into the configuration file in inference engine 316.

As detailed herein, one or more embodiments include incorporating topology awareness to determine the best values for multiple systems with different layouts, configurations, etc. Additionally or alternatively, at least one embodiment includes running at least a portion of the techniques detailed herein on top of a software development kit for deep learning inference (e.g., TensorRT), wherein customized optimization can be carried out on each type of system. Also, such an embodiment includes reducing, relative to conventional approaches, the time required to determine optimal hyperparameter sets as well as reducing the human errors related thereto.

In one or more embodiments, an optimization engine can be added and/or incorporated, for example, into deep learning pipelines in Kubeflow or something similar. Such an embodiment can include combining the optimization engine with a software development kit for a deep learning inference server docker, forming a component that allows users to download and/or provide tuned pre-installed inference servers. In connection with a datacenter that runs an inference workload on a large number of servers with exactly the same configuration, an example embodiment can include gathering all configuration data of the system(s) preemptively and performing one of more techniques detailed herein such that the best values can be saved in a database ahead of time. Accordingly, performance improves on the entire datacenter with no additional hardware cost and no additional run time. Additionally or alternatively, such a datacenter can use idle resources during non-peak hours for optimization.

It is to be appreciated that a “model,” as used herein, refers to an electronic digitally stored set of executable instructions and data values, associated with one another, which are capable of receiving and responding to a programmatic or other digital call, invocation, and/or request for resolution based upon specified input values, to yield one or more output values that can serve as the basis of computer-implemented recommendations, output data displays, machine control, etc. Persons of skill in the field may find it convenient to express models using mathematical equations, but that form of expression does not confine the model(s) disclosed herein to abstract concepts; instead, each model herein has a practical application in a processing device in the form of stored executable instructions and data that implement the model using the processing device.

FIG. 5 is a flow diagram of a process for automated topology-aware deep learning inference tuning in an illustrative embodiment. It is to be understood that this particular process is only an example, and additional or alternative processes can be carried out in other embodiments.

In this embodiment, the process includes steps 500 through 508. These steps are assumed to be performed by automated deep learning inference tuning system 105 utilizing elements 112, 114 and 116.

Step 500 includes obtaining input information from one or more systems associated with a datacenter. In at least one embodiment, obtaining input information includes communicating with at least one load balancing component associated with the datacenter. Also, in one or more embodiments, the one or more systems include multiple systems with multiple different layouts and multiple different configurations.

Step 502 includes detecting topological information associated with at least a portion of the one or more systems by processing at least a portion of the input information, wherein the topological information is related to hardware topology. Step 504 includes automatically selecting one or more of multiple hyperparameters of at least one deep learning model based at least in part on the detected topological information. In at least one embodiment, such an automatic selection step can be based at least in part on the detected topological information and one or more performance variables. Such performance variables can include, for example, maintenance of a given level of quality of service associated with the model, increased throughput associated with the model, accuracy of the model, latency associated with the model, etc. Also, in at least one embodiment, the at least one deep learning model includes one or more of at least one binary search model, at least one genetic algorithm, at least one Bayesian model, at least one MetaRecentering model, at least one covariance matrix adaption (CMA) model, at least one Nelder-Mead model, and at least one differential evolution model.

Step 506 includes determining a status of at least a portion of the detected topological information by processing, during an inference phase of the at least one deep learning model, the detected topological information and data from at least one systems-related database. Step 508 includes performing, in connection with at least a portion of the one or more selected hyperparameters of the at least one deep learning model, one or more automated actions based at least in part on the determining. In at least one embodiment, determining a status includes determining a first status indicating that the at least a portion of the detected topological information is part of previous topological information, and performing one or more automated actions includes automatically retrieving one or more values from the at least one systems-related database upon determining the first status. Additionally or alternatively, determining a status can include determining a second status indicating that the at least a portion of the detected topological information is not part of previous topological information, and in such an embodiment, performing one or more automated actions can include determining one or more hyperparameter values for the one or more selected hyperparameters of the at least one deep learning model upon determining the second status, wherein determining the one or more hyperparameter values is based at least in part on analyzing a set of one or more rules. It is to be appreciated that such noted status indications are merely examples implemented in connection with one or more embodiments, and other examples of a status can include new, not new, previously existing and not previously existing.

At least one embodiment can further include automatically implementing the one or more determined hyperparameter values in the at least one deep learning model and/or outputting the one or more determined hyperparameter values to one or more production systems associated with the datacenter. Additionally or alternatively, such an embodiment can include automatically generating data pertaining to the one or more determined hyperparameter values in JSON format.

In at least one embodiment, performing one or more automated actions includes translating results of the determining and outputting at least a portion of the translated results via at least one user interface. In such an embodiment, outputting at least a portion of the translated results via at least one user interface can include outputting the at least a portion of the translated results via at least one web graphical user interface.

Accordingly, the particular processing operations and other functionality described in conjunction with the flow diagram of FIG. 5 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to automatically perform topology-aware tuning of deep learning models during an inference phase. These and other embodiments can effectively overcome problems associated with performing topology-indifferent hyperparameter tuning exclusively during the training phase.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

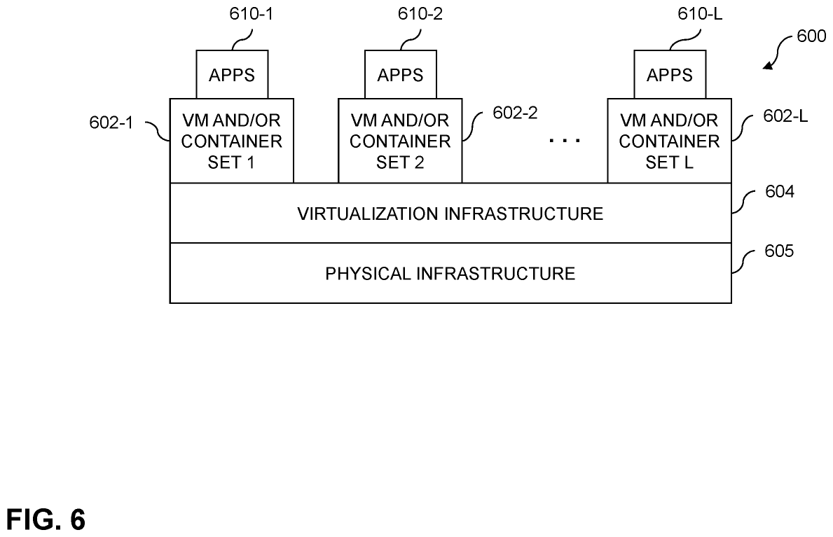

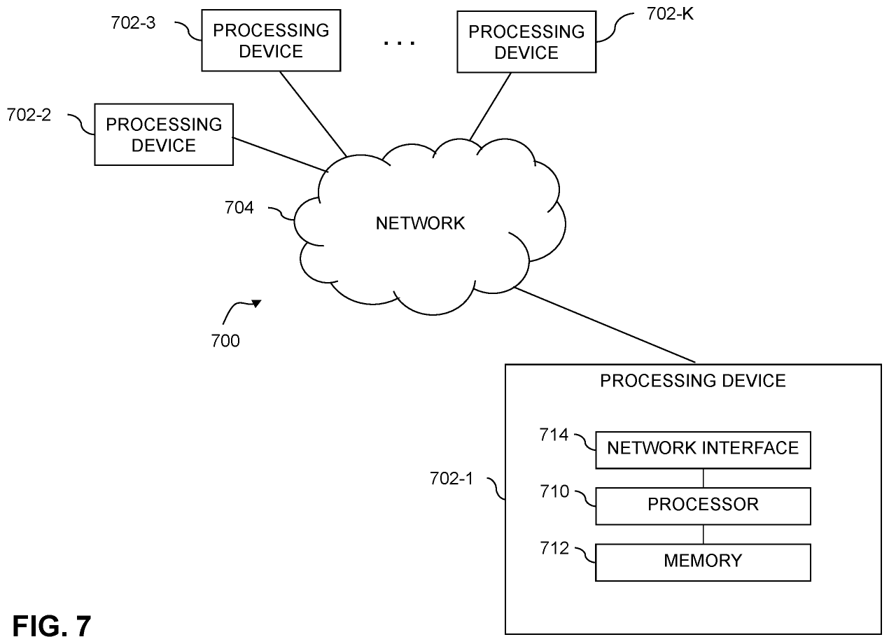

Illustrative embodiments of processing platforms will now be described in greater detail with reference to FIGS. 6 and 7. Although described in the context of system 100, these platforms may also be used to implement at least portions of other information processing systems in other embodiments.

FIG. 6 shows an example processing platform comprising cloud infrastructure 600. The cloud infrastructure 600 comprises a combination of physical and virtual processing resources that are utilized to implement at least a portion of the information processing system 100. The cloud infrastructure 600 comprises multiple virtual machines (VMs) and/or container sets 602-1, 602-2, . . . 602-L implemented using virtualization infrastructure 604. The virtualization infrastructure 604 runs on physical infrastructure 605, and illustratively comprises one or more hypervisors and/or operating system level virtualization infrastructure. The operating system level virtualization infrastructure illustratively comprises kernel control groups of a Linux operating system or other type of operating system.

The cloud infrastructure 600 further comprises sets of applications 610-1, 610-2, . . . 610-L running on respective ones of the VMs/container sets 602-1, 602-2, . . . 602-L under the control of the virtualization infrastructure 604. The VMs/container sets 602 comprise respective VMs, respective sets of one or more containers, or respective sets of one or more containers running in VMs. In some implementations of the FIG. 6 embodiment, the VMs/container sets 602 comprise respective VMs implemented using virtualization infrastructure 604 that comprises at least one hypervisor.

A hypervisor platform may be used to implement a hypervisor within the virtualization infrastructure 604, wherein the hypervisor platform has an associated virtual infrastructure management system. The underlying physical machines comprise one or more distributed processing platforms that include one or more storage systems.

In other implementations of the FIG. 6 embodiment, the VMs/container sets 602 comprise respective containers implemented using virtualization infrastructure 604 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 600 shown in FIG. 6 may represent at least a portion of one processing platform. Another example of such a processing platform is processing platform 700 shown in FIG. 7.

The processing platform 700 in this embodiment comprises a portion of system 100 and includes a plurality of processing devices, denoted 702-1, 702-2, 702-3, . . . 702-K, which communicate with one another over a network 704.

The network 704 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 702-1 in the processing platform 700 comprises a processor 710 coupled to a memory 712.

The processor 710 comprises a microprocessor, a microcontroller, an ASIC, an FPGA or other type of processing circuitry, as well as portions or combinations of such circuitry elements.

The memory 712 comprises RAM, ROM or other types of memory, in any combination.

The memory 712 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 702-1 is network interface circuitry 714, which is used to interface the processing device with the network 704 and other system components, and may comprise conventional transceivers.

The other processing devices 702 of the processing platform 700 are assumed to be configured in a manner similar to that shown for processing device 702-1 in the figure.

Again, the particular processing platform 700 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of a distributed processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
obtaining input information from one or more systems associated with a datacenter;
detecting topological information associated with at least a portion of the one or more systems by processing at least a portion of the input information, wherein the topological information is related to hardware topology;
automatically selecting one or more of multiple hyperparameters of at least one deep learning model based at least in part on the detected topological information;
determining a status of at least a portion of the detected topological information by processing, during an inference phase of the at least one deep learning model, the detected topological information and data from at least one systems-related database; and
performing, in connection with at least a portion of the one or more selected hyperparameters of the at least one deep learning model, one or more automated actions based at least in part on the determining;
wherein the method is performed by at least one processing device comprising a processor coupled to a memory.

2. The computer-implemented method of claim 1, wherein determining a status comprises determining a first status indicating that the at least a portion of the detected topological information is part of previous topological information, and wherein performing one or more automated actions comprises automatically retrieving one or more values from the at least one systems-related database upon determining the first status.

3. The computer-implemented method of claim 1, wherein determining a status comprises determining a second status indicating that the at least a portion of the detected topological information is not part of previous topological information, and wherein performing one or more automated actions comprises determining one or more hyperparameter values for the one or more selected hyperparameters of the at least one deep learning model upon determining the second status, wherein determining the one or more hyperparameter values is based at least in part on analyzing a set of one or more rules.

4. The computer-implemented method of claim 3, further comprising at least one of:
automatically implementing the one or more determined hyperparameter values in the at least one deep learning model; and
outputting the one or more determined hyperparameter values to one or more production systems associated with the datacenter.

5. The computer-implemented method of claim 3, further comprising:
automatically generating data pertaining to the one or more determined hyperparameter values in JavaScript object notation format.

6. The computer-implemented method of claim 1, wherein performing one or more automated actions comprises translating results of the determining and outputting at least a portion of the translated results via at least one user interface.

7. The computer-implemented method of claim 6, wherein outputting at least a portion of the translated results via at least one user interface comprises outputting the at least a portion of the translated results via at least one web graphical user interface.

8. The computer-implemented method of claim 1, wherein obtaining input information comprises communicating with at least one load balancing component associated with the datacenter.

9. The computer-implemented method of claim 1, wherein the one or more systems comprise multiple systems with multiple different layouts and multiple different configurations.

10. The computer-implemented method of claim 1, wherein the at least one deep learning model comprises one or more of at least one binary search model, at least one genetic algorithm, at least one Bayesian model, at least one MetaRecentering model, at least one covariance matrix adaption (CMA) model, at least one Nelder-Mead model, and at least one differential evolution model.

11. The computer-implemented method of claim 1, wherein automatically selecting one or more of multiple hyperparameters of at least one deep learning model comprises automatically selecting one or more of multiple hyperparameters of the at least one deep learning model based at least in part on the detected topological information and one or more performance variables.

12. A non-transitory processor-readable storage medium having stored therein program code of one or more software programs, wherein the program code when executed by at least one processing device causes the at least one processing device:
to obtain input information from one or more systems associated with a datacenter;
to detect topological information associated with at least a portion of the one or more systems by processing at least a portion of the input information, wherein the topological information is related to hardware topology;
to automatically select one or more of multiple hyperparameters of at least one deep learning model based at least in part on the detected topological information;
to determine a status of at least a portion of the detected topological information by processing, during an inference phase of the at least one deep learning model, the detected topological information and data from at least one systems-related database; and
to perform, in connection with at least a portion of the one or more selected hyperparameters of the at least one deep learning model, one or more automated actions based at least in part on the determining.

13. The non-transitory processor-readable storage medium of claim 12, wherein determining a status comprises determining a first status indicating that the at least a portion of the detected topological information is part of previous topological information, and wherein performing one or more automated actions comprises automatically retrieving one or more values from the at least one systems-related database upon determining the first status.

14. The non-transitory processor-readable storage medium of claim 12, wherein determining a status comprises determining a second status indicating that the at least a portion of the detected topological information is not part of previous topological information, and wherein performing one or more automated actions comprises determining one or more hyperparameter values for the one or more selected hyperparameters of the at least one deep learning model upon determining the second status, wherein determining the one or more hyperparameter values is based at least in part on analyzing a set of one or more rules.

15. The non-transitory processor-readable storage medium of claim 12, wherein the program code when executed by the at least one processing device further causes the at least one processing device:
to automatically implement the one or more determined hyperparameter values in the at least one deep learning model.

16. The non-transitory processor-readable storage medium of claim 12, wherein performing one or more automated actions comprises translating results of the determining and outputting at least a portion of the translated results via at least one user interface.

17. An apparatus comprising:
at least one processing device comprising a processor coupled to a memory;
the at least one processing device being configured:
to obtain input information from one or more systems associated with a datacenter;
to detect topological information associated with at least a portion of the one or more systems by processing at least a portion of the input information, wherein the topological information is related to hardware topology;
to automatically select one or more of multiple hyperparameters of at least one deep learning model based at least in part on the detected topological information;
to determine a status of at least a portion of the detected topological information by processing, during an inference phase of the at least one deep learning model, the detected topological information and data from at least one systems-related database; and
to perform, in connection with at least a portion of the one or more selected hyperparameters of the at least one deep learning model, one or more automated actions based at least in part on the determining.

18. The apparatus of claim 17, wherein determining a status comprises determining a first status indicating that the at least a portion of the detected topological information is part of previous topological information, and wherein performing one or more automated actions comprises automatically retrieving one or more values from the at least one systems-related database upon determining the first status.

19. The apparatus of claim 17, wherein determining a status comprises determining a second status indicating that the at least a portion of the detected topological information is not part of previous topological information, and wherein performing one or more automated actions comprises determining one or more hyperparameter values for the one or more selected hyperparameters of the at least one deep learning model upon determining the second status, wherein determining the one or more hyperparameter values is based at least in part on analyzing a set of one or more rules.

20. The apparatus of claim 17, wherein the at least one processing device is further configured:
to automatically implement the one or more determined hyperparameter values in the at least one deep learning model.
